(19) United States
(12) Patent Application Publication
(10) Pub. No.: US 2008/0138565 A1
(43) Pub. Date: Jun. 12, 2008

(54) ELASTIC PAD

(76) Inventor: Chih-Hsiang Yang, Tung Hsiao Chen (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/608,115

(22) Filed: Dec. 7, 2006

(51) Int. Cl. B32B 5/04

(52) U.S. Cl. 428/107

(57) ABSTRACT

An elastic pad used in daily life is disposed in a backpack strap, a handbag handle or a sports backpack strap. The pad is composed of at least three longitudinal elastomers connected in parallel. Each elastomer has convex and concave portions arranged alternately. The convex direction of the convex portion and the concave direction of the concave portion are perpendicular to an extending direction of the elastomer and its adjacent elastomer. The convex portions and the concave portions of the adjacent elastomers are arranged alternately. The cross-sectional area of the longitudinal elastomer has a rectangular, circular, elliptic, triangular, pentagon, hexagonal or octagon shape. The convex portion has a convex arched shape, and the concave portion has a concave arched shape or tooth shape. A contact portion between the adjacent elastomers serves as a common portion to constitute an entity. Compared with the prior art, the invention is air-permeable and has the good buffer effect.

### BACKGROUND OF THE INVENTION

(1) Field of the Invention

The invention relates to an elastic pad used in daily life, and more particularly to an elastic pad disposed in a backpack strap or a handbag handle, and further to an elastic pad disposed in a sports backpack strap.

(2) Description of the Prior Art

A backpack used in daily life and work is usually burdened on the shoulder through a strap or straps or carried in the hand. In the sport, such as a golf sport, a pack is usually burdened and moved through the strap or straps. Currently, the typical strap and the strap pad are mostly the flat ribbons. In use, the strap or strap pad is in surface contact with the shoulder of the human body to diverge the local stress on the shoulder in a predetermined extent. However, the air-permeable property thereof is poor and the buffer effect is poor. When the pack is burdened for a longer period of time, the contact portion on the shoulder tends to feel uncomfortable due to the tight press of the large area, and the shoulder feels fatigue quicker.

### SUMMARY OF THE INVENTION

It is therefore an object of the invention to provide an elastic pad capable of overcoming the prior art drawbacks and providing a good air-permeable property and the good buffer effect.

The invention achieves the above-identified object by providing an elastic pad composed of at least three longitudinal elastomers connected in parallel. Each elastomer has convex portions and concave portions arranged alternately. The convex direction of the convex portion and the concave direction of the concave portion are perpendicular to an extending direction of the elastomer and its adjacent elastomer. The convex portions and the concave portions of the adjacent elastomers are arranged alternately.

The shape of the cross-sectional area of the longitudinal elastomer is rectangular, circular, elliptic, triangular, pentagon, hexagonal or octagon.

The convex portion has a convex arched shape, and the concave portion has a concave arched shape.

The convex portion has a convex tooth-like shape, and the concave portion has a concave tooth-like shape.

The elastomers are connected in parallel, and a contact portion between the adjacent elastomers serves as a common portion to constitute an entity.

The elastomers are connected in parallel, and a longitudinal connector between the adjacent elastomers serves as a common portion to constitute an entity.

The elastomers are connected in parallel so that all of the elastomers and one common side constitute an entity. The common side is a sheet-like closed side around the elastomers.

Compared with the prior art, the invention advantageously has the good air-permeable property and the good buffer effect.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing a first elastomer according to a first embodiment of the invention.

FIG. 2 is a pictorial view showing a second elastomer according to the first embodiment of the invention.

FIG. 3 is a pictorial view showing the first embodiment of the invention.

FIG. 4 is a pictorial view showing a second embodiment of the invention.

FIG. 5 is a pictorial view showing a first elastomer according to a third embodiment of the invention.

FIG. 6 is a pictorial view showing a second elastomer according to the third embodiment of the invention.

FIG. 7 is a pictorial view showing the third embodiment of the invention.

FIG. 8 is a pictorial view showing a first elastomer according to a fourth embodiment of the invention.

FIG. 9 is a pictorial view showing a second elastomer according to the fourth embodiment of the invention.

FIG. 10 is a pictorial view showing the fourth embodiment of the invention.

### DETAILED DESCRIPTION OF THE PREFERRED EMBODIMENTS

The invention will be described in detail with reference to the accompanying drawings.

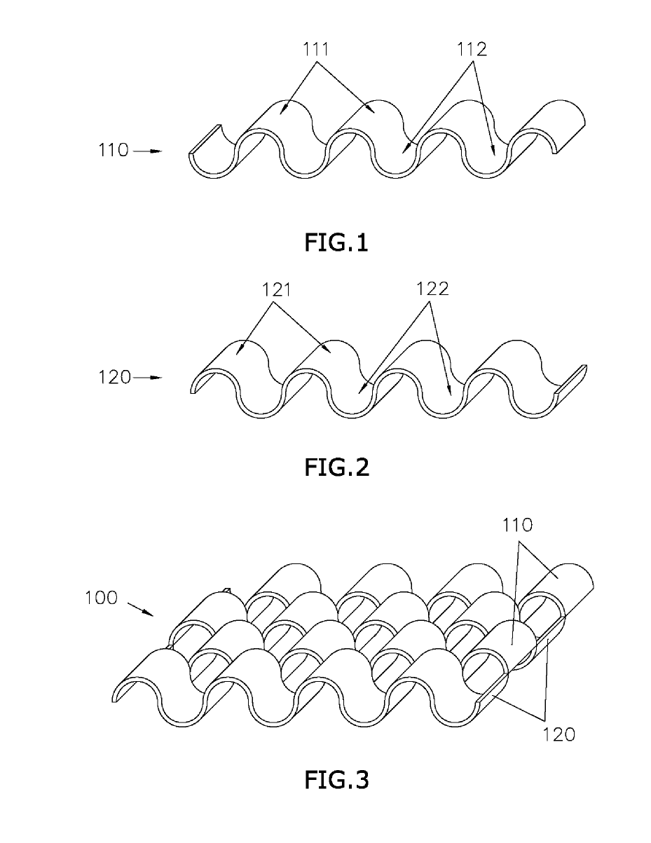

FIGS. 1 to 3 show the first embodiment of the invention. FIG. 1 is a pictorial view showing a first elastomer 110 according to a first embodiment of the invention. The elastomer 110 has convex portions 111 and concave portions 112 arranged alternately. FIG. 2 is a pictorial view showing a second elastomer 120 according to the first embodiment of the invention. The elastomer 120 has convex portions 121 and concave portions 122 arranged alternately. FIG. 3 is a pictorial view showing an elastic pad 100 according to the first embodiment of the invention. The elastic pad 100 is composed of four elastomers connected in parallel. A contact portion between the adjacent elastomers serves as a common portion to constitute an entity. The constituted entity may be formed by way of, without limitation to, integrally molding, adhering, bonding or welding. The convex direction of the convex portion 111 (121) of the elastomer and the concave direction of the concave portion 112 (122) of the elastomer are perpendicular to an extending direction of the elastomer and its adjacent elastomer. The convex portions and the concave portions of the adjacent elastomers are arranged alternately. The elastomer 110 (120) is a longitudinal elastomer having a rectangular cross-sectional area. The convex portion 111 (121) has a convex arched shape, and the concave portion 112 (122) has a concave arched shape.

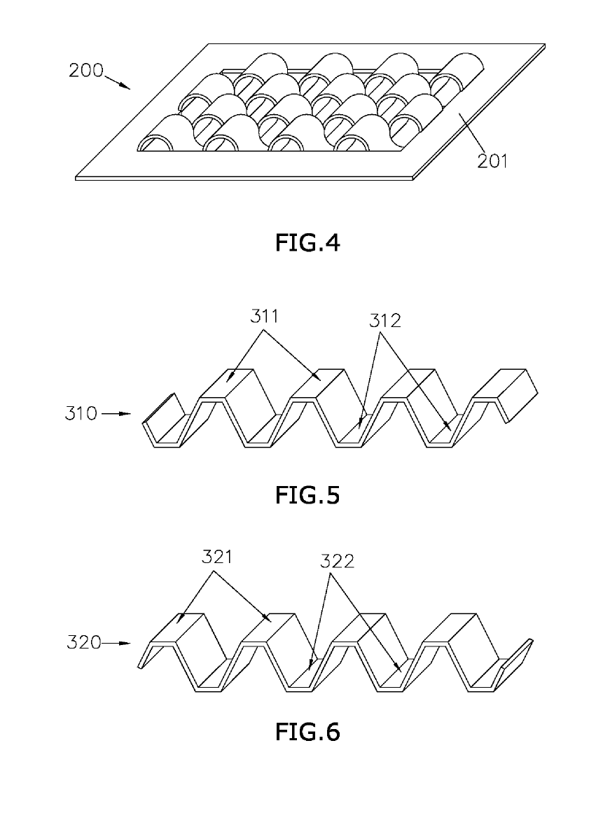

FIG. 4 is a pictorial view showing an elastic pad 200 according to the second embodiment of the invention. As shown in FIG. 4, the elastomers of the elastic pad 200 are completely the same as those of the first embodiment of the invention, and the elastic pad 200 is composed of four elastomers connected in parallel. A contact portion between the adjacent elastomers serves as a common portion to constitute an entity. The constituted entity may be formed by way of, without limitation to, integrally molding, adhering, bonding or welding. The elastic pad includes all the elastomers and one common side 201 to constitute an entity. The common side 201 is a sheet-like closed side disposed around the elastomers.

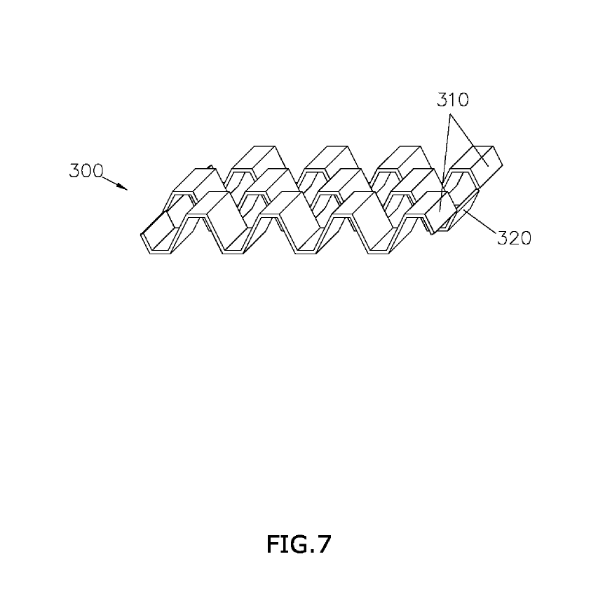

FIGS. 5 to 7 show a third embodiment of the invention. FIG. 5 is a pictorial view showing a first elastomer 310 according to the third embodiment of the invention. The elastomer 310 has convex portions 311 and concave portions 312 arranged alternately. FIG. 6 is a pictorial view showing a second elastomer 320 according to the third embodiment of the invention. The elastomer 320 has convex portions 321 and concave portions 322 arranged alternately. FIG. 7 is a pictorial view showing an elastic pad 300 according to the third embodiment of the invention. The elastic pad 300 is composed of three elastomers connected in parallel. A contact portion between the adjacent elastomers serves as a common portion to constitute an entity. The constituted entity may be formed by way of, without limitation to, integrally molding, adhering, bonding or welding. The convex direction of the convex portion 311 (321) of the elastomer and the concave direction of the concave portion 312 (322) of the elastomer are perpendicular to an extending direction of the elastomer and its adjacent elastomer. The convex portions and the concave portions of the adjacent elastomers are arranged alternately. The elastomer 310 (320) is a longitudinal elastomer having a rectangular cross-sectional area. The convex portion 311 (321) has a convex tooth-like shape, and the concave portion 312 (322) has a concave tooth-like shape.

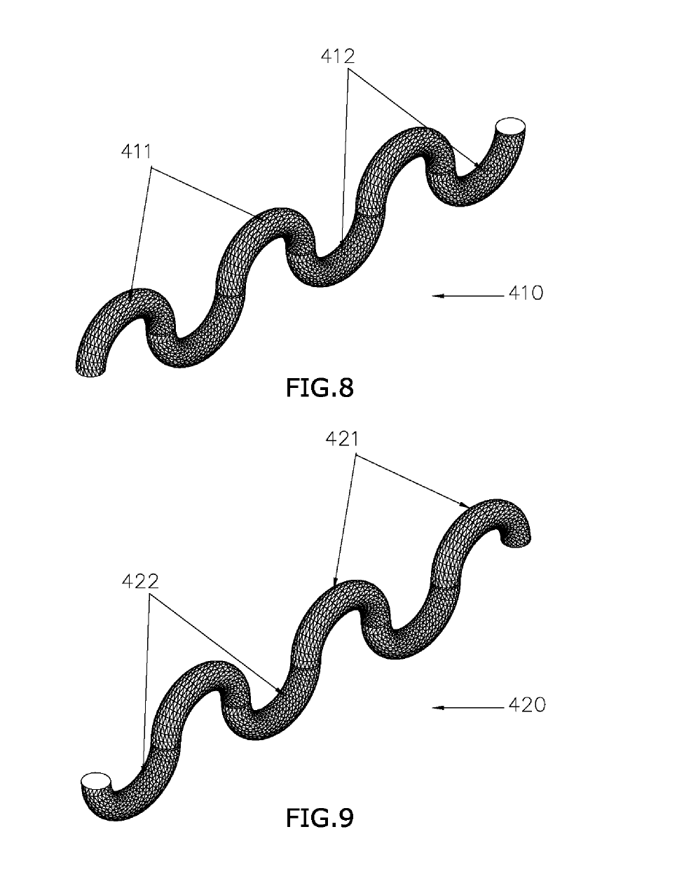

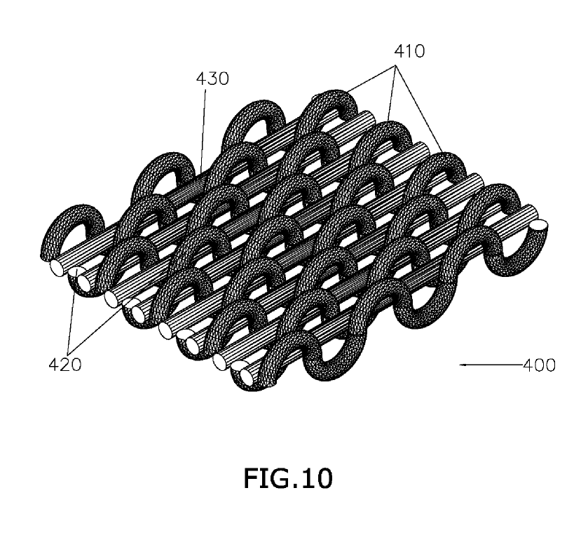

FIGS. 8 to 10 show a fourth embodiment of the invention. FIG. 8 is a pictorial view showing a first elastomer 410 according to the fourth embodiment of the invention. The elastomer 410 has convex portions 411 and concave portions 412 arranged alternately. FIG. 9 is a pictorial view showing a second elastomer 420 according to the fourth embodiment of the invention. The elastomer 420 has convex portions 421 and concave portions 422 arranged alternately. FIG. 10 is a pictorial view showing the elastic pad according to the fourth embodiment of the invention. The elastic pad 400 is composed of eight elastomers connected in parallel. A longitudinal connector 430 between the adjacent elastomers serves as a common portion to constitute an entity. The constituted entity may be formed by way of, without limitation to, integrally molding, adhering, bonding or welding. The convex direction of the convex portion 411 (421) of the elastomer and the concave direction of the concave portion 412 (422) of the elastomer are perpendicular to an extending direction of the elastomer and its adjacent elastomer. The convex portions and the concave portions of the adjacent elastomers are disposed alternately. The elastomer 410 (420) is a longitudinal elastomer having a circular cross-sectional area. The convex portion 411 (421) has a convex arched shape, and the concave portion 412 (422) has a concave arched shape.

The invention provides the elastic pads with the good air-permeable property and the good buffer effect.

The shape of the cross-sectional area of the longitudinal elastomer may be rectangular, circular, elliptic, triangular, pentagon, hexagonal or octagon, or a combination of the above-mentioned shapes. Each of the convex shape of the convex portion and the concave shape of the concave portion may be the arched shape, the tooth-like shape, the polygonal shape or any other shape, or the combination of the above-mentioned shapes. Thus, modifications can be easily made according to the above-mentioned four embodiments and are still deemed as falling within the scope of the invention.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An elastic pad, comprising:
at least three longitudinal elastomers connected in parallel, wherein each of the elastomers has convex portions and concave portions arranged alternately, a convex direction of the convex portion of the elastomer and a concave direction of the concave portion of the elastomer are substantially perpendicular to an extending direction of the elastomer and its adjacent elastomer, and the convex portions and the concave portions of the adjacent elastomers are arranged alternately.

2. The elastic pad according to claim 1, wherein a cross-sectional area of each of the longitudinal elastomers has a rectangular shape, a circular shape, an elliptic shape, a triangular shape, a pentagon shape, a hexagonal shape or an octagon shape.

3. The elastic pad according to claim 1, wherein the convex portion has a convex arched shape, and the concave portion has a concave arched shape.

4. The elastic pad according to claim 1, wherein the convex portion has a convex tooth-like shape, and the concave portion has a concave tooth-like shape.

5. The elastic pad according to claim 1, wherein a contact portion between the adjacent elastomers connected in parallel serves as a common portion to constitute an entity.

6. The elastic pad according to claim 1, wherein a longitudinal connector between the adjacent elastomers connected in parallel serves as a common portion to constitute an entity.

7. The elastic pad according to claim 5, further comprising:
a common side connected to the elastomers to constitute an entity, wherein the common side is a sheet-like closed side disposed around the elastomers.
